(19) United States
(12) Patent Application Publication
(10) Pub. No.: US 2025/0073587 A1
(43) Pub. Date: Mar. 6, 2025

(54) METHOD AND APPARATUS FOR DISPLAYING EFFECT IN VIRTUAL SCENE, MEDIUM, AND PROGRAM PRODUCT

(71) Applicant: Tencent Technology (Shenzhen) Company Limited, Shenzhen (CN)

(72) Inventor: Qianhang HU, Shenzhen (CN)

(73) Assignee: Tencent Technology (Shenzhen) Company Limited, Shenzhen, GD (CN)

(21) Appl. No.: 18/954,511

(22) Filed: Nov. 20, 2024

Related U.S. Application Data
(63) Continuation of application No. PCT/CN2023/112958, filed on Aug. 14, 2023.

(30) Foreign Application Priority Data
Sep. 20, 2022 (CN) 202211144291.2

(51) Int. Cl. A63F 13/5372; A63F 13/52

(52) U.S. Cl. CPC A63F 13/5372; A63F 13/52; A63F 2300/306

(57) ABSTRACT

In a method for displaying an effect in a virtual scene, a main virtual object is displayed in a battle region of the virtual scene. The battle region includes a plurality of battle subregions. A first highlight effect in the plurality of battle subregions is displayed. The first highlight effect indicates that the plurality of battle subregions is available to be selected. A second highlight effect in a selected subregion of the plurality of battle subregions is displayed. The second highlight effect represents an impact attribute of the selected subregion of the main virtual object. The impact attribute is based on a location of the main virtual object and the selected subregion.

### RELATED APPLICATIONS

The present application is a continuation of International Application No. PCT/CN2023/112958, filed on Aug. 14, 2023, which claims priority to Chinese Patent Application No. 202211144291.2, filed on Sep. 20, 2022. The entire disclosures of the prior applications are hereby incorporated by reference.

### FIELD OF THE TECHNOLOGY

This disclosure relates to the field of virtual environments, including to a method and an apparatus for displaying an effect in a virtual scene, a device, a medium, and a program product.

### BACKGROUND OF THE DISCLOSURE

With the rapid development of computer technologies and the diversification of terminals, electronic games are gradually widely used. A massively multiplayer online role-playing game (MMORPG) is a popular game. A virtual scene is displayed on a terminal, and a player may control a virtual object by using the terminal, to perform character activities in the virtual scene.

In the related art, when the player controls the virtual object to perform virtual activities, for example, perform a virtual battle, in the virtual scene, there is indication information in the virtual scene in a process of the virtual battle, and the indication information is configured for prompting the player to control the virtual object to move to a designated region to avoid being attacked in the battle.

However, the indication information usually indicates for a fixed designated region. As a result, the player can learn of the single designated region in the virtual scene. This single indication manner enables the player to learn of a specific position of the designated region without relying on prompt information after a plurality of times of games are performed, thereby avoiding an attack. Consequently, the player has poor game interactivity, and prompt efficiency of designated information is poor, resulting in a waste of data processing resources of a server.

### SUMMARY

Embodiments of this disclosure provide a method and an apparatus for displaying an effect in a virtual scene, a device, a medium, and a program product, which can improve diversity of effect display, thereby improve efficiency of information indication.

According to an aspect, a method for displaying an effect in a virtual scene is provided. In the method, a main virtual object is displayed in a battle region of the virtual scene. The battle region includes a plurality of battle subregions. A first highlight effect in the plurality of battle subregions is displayed. The first highlight effect indicates that the plurality of battle subregions is available to be selected. A second highlight effect in a selected subregion of the plurality of battle subregions is displayed. The second highlight effect represents an impact attribute of the selected subregion of the main virtual object. The impact attribute is based on a location of the main virtual object and the selected subregion.

According to an aspect, an information processing apparatus, such as a virtual scene effect display apparatus, is provided. The apparatus includes processing circuitry that is configured to display a main virtual object in a battle region of a virtual scene. The battle region includes a plurality of battle subregions. The processing circuitry is configured to display a first highlight effect in the plurality of battle subregions. The first highlight effect indicates that the plurality of battle subregions is available to be selected. The processing circuitry is configured to display a second highlight effect in a selected subregion of the plurality of battle subregions. The second highlight effect represents an impact attribute of the selected subregion of the main virtual object. The impact attribute is based on a location of the main virtual object and the selected subregion.

According to an aspect, a computer device is provided. The computer device includes a processor and a memory, the memory storing at least one instruction, at least one program, a code set or an instruction set, the at least one instruction, the at least one program, the code set or the instruction set being loaded and executed by the processor to implement the virtual scene effect display method according to any one of the foregoing embodiments of this disclosure.

According to an aspect, a non-transitory computer-readable storage medium is provided. The non-transitory computer-readable storage medium stores at least one instruction, at least one program, a code set, or an instruction set, the at least one instruction, the at least one program, the code set or the instruction set being loaded and executed by a processor to perform the virtual scene effect display method according to this disclosure.

According to an aspect, a computer program product or a computer program is provided. The computer program product or the computer program includes computer instructions, the computer instructions being stored in a computer-readable storage medium. A processor of a computer device reads the computer instructions from the computer-readable storage medium and executes the computer instructions to cause the computer device to perform the virtual scene effect display method according to the foregoing embodiments.

When a main control virtual object is located in a battle region in a virtual scene, a first highlight effect of a plurality of sub-regions is displayed in the battle region, the first highlight effect represents that the sub-region is a to-be-selected candidate region. After the display of the first highlight effect ends, a second highlight effect is displayed on a selected sub-region, to represent an attribute impact of the selected sub-region on the main control virtual object. Finally, an attribute impact result is displayed based on a position relationship between the main control virtual object and the selected sub-region. That is, a player can be prompted for a current candidate region by displaying the first highlight effect, and then the second highlight effect of the selected sub-region is displayed. A region causing an attribute impact can be affected by two highlight effects. In this way, the player cannot know a specific position of the selected sub-region in advance, and diversity of effect display can be improved, thereby improving interactivity of the player in the game process. In addition, a manner of displaying the highlight effect can play a push role for a game process, thereby improving resources of a server.

### BRIEF DESCRIPTION OF THE DRAWINGS

To describe the technical solutions in the embodiments of this disclosure more clearly, the following briefly introduces the accompanying drawings for describing the embodiments. The accompanying drawings in the following description show merely some embodiments of this disclosure, and a person of ordinary skill in the art may still derive other drawings from these accompanying drawings.

FIG. 1 is a schematic diagram of an effect display method of a virtual scene according to an example embodiment of this disclosure.

FIG. 2 is a schematic diagram of an implementation environment according to an example embodiment of this disclosure.

FIG. 3 is a structural block diagram of an electronic device according to an example embodiment of this disclosure.

FIG. 4 is a flowchart of a method for displaying an effect in a virtual scene according to an example of this disclosure.

FIG. 5 is a flowchart of a method for displaying an effect in a virtual scene according to an example of this disclosure.

FIG. 6 is a schematic diagram of a second highlight display effect according to an example of this disclosure.

FIG. 7 is a schematic diagram of region prompt information according to an example of this disclosure.

FIG. 8 is a schematic diagram of a roulette effect according to an example of this disclosure.

FIG. 9 is a flowchart of a method for displaying an effect in a virtual scene according to an example of this disclosure.

FIG. 10 is a schematic diagram of enabling a highlight display mechanism according to an example of this disclosure.

FIG. 11 is a schematic diagram of displaying a first highlight effect in a single round according to an example of this disclosure.

FIG. 12 is a schematic diagram of an attribute debuff effect of a virtual scene according to an example of this disclosure.

FIG. 13 is a schematic diagram of skill casting of a battle virtual object according to an example of this disclosure.

FIG. 14 is a schematic diagram of indication transmission according to an example of this disclosure.

FIG. 15 is a schematic diagram of an editing interface of a battle virtual object according to an example of this disclosure.

FIG. 16 is a schematic diagram of region division according to an example of this disclosure.

FIG. 17 is a structural block diagram of a virtual scene effect display apparatus according to an example of this disclosure.

FIG. 18 is a structural block diagram of a virtual scene effect display apparatus according to another example of this disclosure.

FIG. 19 is a structural block diagram of a terminal according to an example of this disclosure.

### DESCRIPTION OF EMBODIMENTS

To make objectives, technical solutions, and advantages of this disclosure clearer, implementations of this disclosure are further described below in detail with reference to the accompanying drawings.

Examples of embodiments are described in further detail herein with the accompanying drawings. When the following descriptions are made with reference to the accompanying drawings, the same numbers in different accompanying drawings represent the same or similar elements. The following example embodiments are merely examples of the apparatus and method according to some aspects of this disclosure as recited in the appended claims.

The descriptions of the terms are provided as examples only and are not intended to limit the scope of the disclosure.

Virtual environment: It is a virtual environment displayed (or provided) when an application runs on a terminal. The virtual environment may be a simulated environment of the real world, or may be a semi-simulated semi-fictional three-dimensional (3D) environment, or may be an entirely fictional 3D environment. The virtual environment may be any one of a 2D virtual environment, 2.5D virtual environment, and 3D virtual environment. Description is made by using an example in which the virtual environment is a 3D virtual environment in the following embodiments, but this is not limited.

Virtual object: It is a movable object in a virtual environment. The movable object may be a virtual chess piece, a virtual character, a virtual animal, a cartoon character, and the like. For example: a character, an animal, a plant, an oil drum, a wall, or a stone displayed in the virtual environment. In some embodiments, the virtual object is a three-dimensional model created based on a skeletal animation technology. Each virtual object has a shape and a volume in the virtual environment, and occupies some space in the virtual environment.

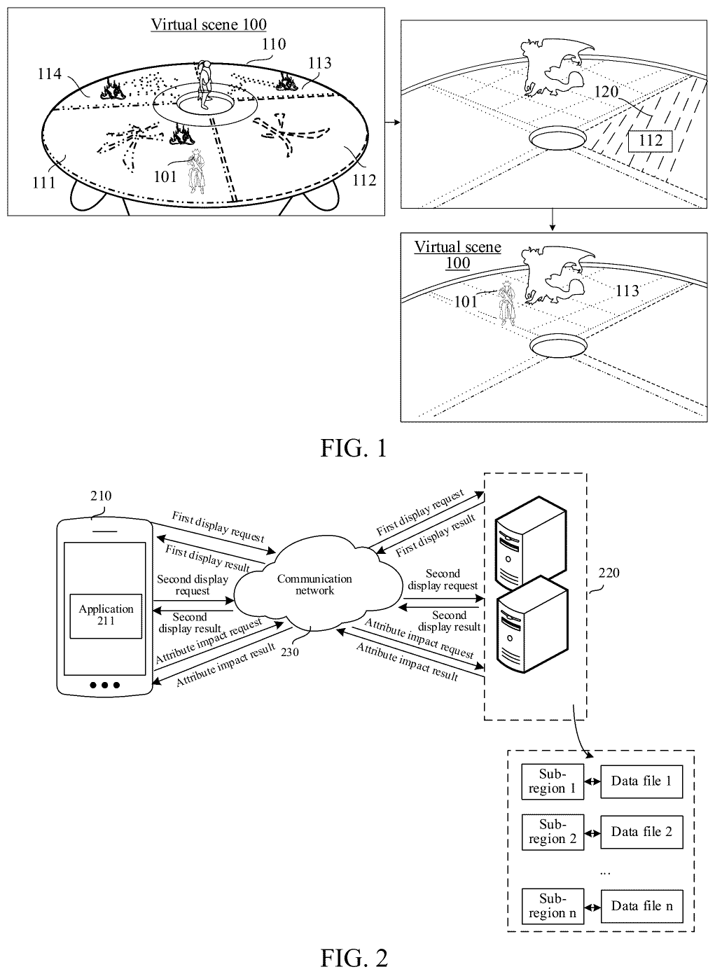

First, FIG. 1 is a schematic diagram of a method for displaying an effect in a virtual scene according to an example of this disclosure. As shown in FIG. 1, a virtual scene 100 is displayed. The virtual scene 100 includes a main control virtual object 101 in a battle region 110. The battle region 110 includes a plurality of sub-regions, including a sub-region 111, a sub-region 112, a sub-region 113, and a sub-region 114 in this embodiment (different sub-regions are distinguished by different region display elements, for example, a “water” typeface is displayed in the sub-region 111, and a “fire” typeface is displayed in the sub-region 112).

A first highlight effect 120 is displayed on a plurality of sub-regions (subregions) in the battle region 110. In a display process of the first highlight effect 120, the first highlight effect 120 (the first highlight effect 120 in this embodiment is illustrated by using oblique-line filling as an example) is displayed on some sub-regions (the sub-region 112 in this embodiment). After the display of the first highlight effect 120 ends, a second highlight effect 140 (the second highlight effect 140 in this embodiment is illustrated by using a grid line as an example) is displayed in a selected sub-region (the sub-region 113 in this embodiment), representing that an attribute value of the main control virtual object 101 may not change in the selected sub-region. When the main control virtual object 101 is located in the selected sub-region, an attribute impact result is implemented as that an attribute result of the main control virtual object 101 does not change.

Next, FIG. 2 is a schematic diagram of an environment according to an example of this disclosure. The example includes: a terminal 210, a server 220, and a communication network 230. The terminal 210 is connected to the server 220 through the communication network 230.

An application 211 is installed and run in the terminal 210. The application 211 is an application supporting a 2D virtual environment or a 3D virtual environment. A target application 211 may be any one of a virtual reality application, a 3D map application, a cheese game, a simulation game, a puzzle game, a massive multiplayer online role-playing game (MMORPG), a third-person shooting (TPS) game, a first-person shooting (FPS) game, a multiplayer online battle arena (MOBA) game, or a multilayer gunfight survival game. In a possible implementation, the application 211 may be a stand-alone version application, for example, a stand-alone version policy game program, and may also be a network online version application.

In an example, when the application 211 is the stand-alone version application, the virtual scene is currently displayed in the application 211. The virtual scene includes the main control virtual object controlled by a terminal account logged in by the terminal 210. The main control virtual object is located in the battle region including the plurality of sub-regions. The terminal 210 pre-stores a rendering data file corresponding to each sub-region. The data file includes effect rendering data (first rendering data and second rendering data) and attribute impact data corresponding to the sub-region. When the terminal 210 displays the first highlight effect in the plurality of sub-regions in the battle region, the terminal 210 respectively obtains first rendering data corresponding to the first highlight effect from data files corresponding to the sub-regions, to render the sub-region in the virtual scene through the first rendering data. The first highlight effect is configured for representing that the sub-region belongs to a to-be-selected candidate region. After the display of the first highlight effect ends, the terminal 210 selects second rendering data corresponding to a second highlight effect from a data file corresponding to the selected sub-region, so that the second highlight effect is displayed in the selected sub-region, and finally an attribute impact result of the main control virtual object is displayed based on a position relationship between the main control virtual object and the selected sub-region. If the main control virtual object is located in the selected sub-region, the terminal 210 obtains the attribute impact data corresponding to the selected sub-region from the data file corresponding to the selected sub-region, and causes a corresponding attribute impact result to the main control virtual object. If the main control virtual object is not located in the selected sub-region, the terminal 210 obtains corresponding attribute impact data from data files respectively corresponding to other sub-regions, and causes the corresponding attribute impact result to the main control virtual object.

In an example, when the application 211 is the network online version application, as shown in FIG. 2, the application 211 is currently implemented as a massive multiplayer online role-playing game, and a scene picture in the battle region in the virtual scene is displayed. The battle region includes a plurality of sub-regions. After a player triggers a highlight effect display mechanism, the terminal 210 transmits a first display request to the server 220. The first display request is configured for requesting to display the first highlight effect in the plurality of sub-regions in the battle region.

The server 220 stores a data file corresponding to each sub-region. After receiving the first display request sent by the terminal 210, the server 220 obtains the first rendering data corresponding to the sub-region from the data file corresponding to each sub-region, and generates a corresponding first display result and feeds back the corresponding first display result to the terminal 210.

After receiving the first display result, the terminal 210 performs picture rendering on the sub-region based on first rendering data corresponding to each sub-region in the first display result, to display the plurality of rounds of first highlight effects in the plurality of sub-regions. After the display of the first highlight effect ends, the terminal 210 sends a second display request to the server 220. The second display request is configured for requesting to display the second highlight effect in the battle region.

After receiving the second display request sent by the terminal 210, the server 220 determines a selected sub-region from the plurality of sub-regions, obtains second rendering data from a data file corresponding to the selected sub-region, generates a second display result, and feeds back the second display result to the terminal 210.

After receiving the second display result sent by the server 220, the terminal 210 performs picture rendering on the selected sub-region based on the second rendering data in the second display result, to display the second highlight effect of the selected sub-region.

Based on the position relationship between the main control virtual object and the selected sub-region, the terminal 210 sends an attribute impact request to the server 220, and the attribute impact request is configured for requesting the selected sub-region to cause an attribute impact on the main control virtual object. The attribute impact request includes the position relationship between the main control virtual object and the selected sub-region.

After receiving the attribute impact request, the server 220 obtains a corresponding attribute impact result based on the position relationship and feeds back the corresponding attribute impact result to the terminal 210. After receiving the attribute impact result, the terminal 210 correspondingly displays the attribute impact result.

The foregoing terminal 210 may be an example. The terminal may be terminal devices in a plurality of forms such as a desktop computer, a portable laptop computer, a mobile phone, a tablet computer, an e-book reader, a Moving Picture Experts Group Audio Layer III (MP3) player, a Moving Picture Experts Group Audio Layer IV (MP4) player, a smart television, and a smart vehicle. This is not limited in this embodiment of this disclosure.

The server 220 includes at least one of one server, a plurality of servers, a cloud computing platform, or a virtualization center. In some embodiments, the server 220 is responsible for primary computing work and the terminal 210 is responsible for secondary computing work; or the server 220 is responsible for the secondary computing work and the terminal 210 is responsible for the primary computing work; or a distributed computing architecture is adopted between the server 220 and the terminal 210 to perform collaborative computing.

The foregoing server may be an independent physical server, or may be a server cluster or a distributed system formed by a plurality of physical servers, or may be a cloud server that provides basic cloud computing services such as a cloud service, cloud security, a cloud database, cloud computing, a cloud function, cloud storage, a network service, cloud communication, a middleware service, a domain name service, a security service, a content delivery network (CDN), big data, and an artificial intelligence platform.

The cloud technology is a hosting technology that unifies a series of resources such as hardware, software, and networks in a wide region network or a local region network to implement computing, storage, processing, and sharing of data.

In some embodiments, the foregoing server may alternatively be implemented as a node in a blockchain system.

The information (including, but not limited to, player device information, player personal information, and the like), data (including, but not limited to, data for analysis, stored data, displayed data, and the like), and signals involved in this application all are authorized by the player or fully authorized by each party, and the collection, use, and processing of relevant data need to comply with relevant laws and regulations of relevant regions. For example, player information involved in this application is obtained with full authorization.

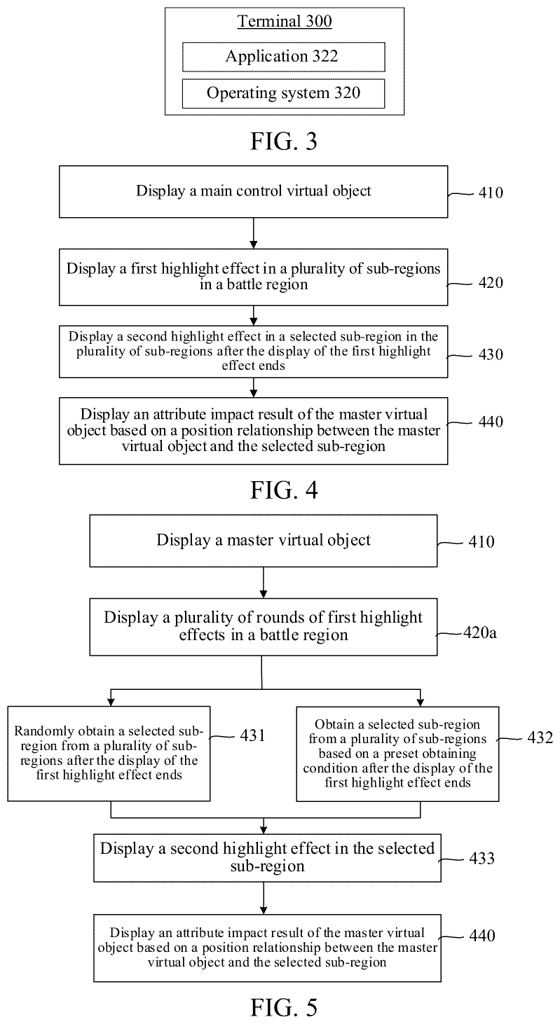

FIG. 3 is a structural block diagram of an electronic device according to an example of this disclosure. The electronic device 300 includes: an operating system 320 and an application 322.

The operating system 320 is basic software provided for the application 322 to perform secure access to computer hardware.

The application 322 is an application supporting a virtual environment. In some embodiments, the application 322 is an application supporting a 3D virtual environment. The application 322 may be any one of a virtual reality application, a 3D map application, a massive multiplayer online role-playing game (MMORPG), a third-person shooting (TPS) game, a first-person shooting (FPS) game, a multiplayer online battle arena (MOBA) game, a multilayer gunfight survival game, a social game, a puzzle game, or a simulation game. The application 322 may be a stand-alone version application, such as a stand-alone version game program, or may be a network online version application.

With reference to the foregoing introduction, the virtual scene effect display method provided in this disclosure is described. The method may be performed by the server or the terminal, or may be jointly performed by the server and the terminal. In this embodiment of this disclosure, an example in which the method is performed by the terminal is configured for description. As shown in FIG. 4, the method includes the following operations.

Operation 410: Display a main control virtual object.

The main control virtual object is located in a battle region in a virtual scene, and the battle region includes a plurality of sub-regions.

For example, the main control virtual object is a virtual object controlled by a terminal account logged in by the terminal. The terminal account controls the main control virtual object to perform virtual activities in the virtual scene through the terminal.

In an example, a picture corresponding to the virtual scene is a picture obtained by observing the virtual scene from a perspective of the main control virtual object.

In an example, the perspective of the main control virtual object includes a first-person perspective; or the perspective of the main control virtual object includes a third-person perspective. This is not limited.

For example, the battle region refers to a region in which interactive activities are performed. In an example, the terminal account may control the main control virtual object to play a virtual battle with another virtual object (for example: a battle virtual object) in the battle region.

In some embodiments, the plurality of sub-regions refers to a plurality of regions obtained by performing region division on the battle region.

In some embodiments, the plurality of sub-regions are pre-divided regions; or the plurality of sub-regions are regions obtained through dividing based on the main control virtual object in real time in a process of the battle region. This is not limited.

In some embodiments, the plurality of sub-regions are regions with a same region area; or the plurality of sub-regions are regions with different region areas. This is not limited.

In an example, the player can perceive the plurality of sub-regions in the battle region. That is, a division result of the plurality of sub-regions in the battle region is displayed in a current virtual scene picture.

In an example, a current player cannot perceive the plurality of sub-regions in the battle region. That is, the battle region is displayed in the current virtual scene picture, and the division result of the plurality of sub-regions is not displayed.

In some embodiments, a manner of distinguishing the plurality of sub-regions includes at least one of the following manners:

1. Different sub-regions are distinguished by displaying different region elements in the plurality of sub-regions. For example: there are at least two sub-regions that display different color identifiers, a region A displays in a blue identifier, and a region B displays in a yellow identifier.

2. Different sub-regions are distinguished by different region outlines corresponding to the plurality of sub-regions. For example: The battle region is implemented as a square region, and the battle region includes a circular sub-region, a rectangular sub-region, and a triangular sub-region.

3. When the main control virtual object moves into a sub-region, region indication information is displayed in the virtual scene picture. The region indication information is configured for indicating that a current main control virtual object is located in the sub-region. For example: When the main control virtual object moves to the sub-region n, the region indication information “You are currently located in a sub-region n” is displayed in the current virtual scene picture.

The foregoing manner of distinguishing the plurality of sub-regions is only illustrative example. This is not limited in this embodiment of this disclosure.

In some embodiments, all regions in the battle region are divided into the plurality of sub-regions; or part of the regions in the battle region are divided into the plurality of sub-regions. That is, in a current case, the battle region includes regions that do not belong to the plurality of sub-regions. This is not limited.

Operation 420: Display a first highlight effect in a plurality of sub-regions in a battle region.

The first highlight effect is configured for representing that the plurality of sub-regions are to-be-selected candidate regions.

For example, the to-be-selected candidate region is configured for representing that the sub-region is a candidate region for displaying the second highlight effect.

In some embodiments, when the sub-region displays the first highlight effect, it represents that the sub-region belongs to the to-be-selected candidate region; or when a number of display times of the first highlight effect displayed by the sub-region reaches a preset number threshold, it represents that the sub-region belongs to the to-be-selected candidate region. This is not limited.

In some embodiments, a display manner of the first highlight effect includes at least one of the following display manners:

1. Display a first highlight effect of at least one round on the plurality of sub-regions. The first highlight effect is displayed for at least one sub-region in the plurality of sub-regions in each round.

2. Continuously display the first highlight effect for some sub-regions in the plurality of sub-regions.

3. Alternately display the first highlight effect in the plurality of sub-regions in turn.

The foregoing display manner of the first highlight effect is only illustrative example. This is not limited in this embodiment of this disclosure.

In some embodiments, the first highlight effect displayed in the plurality of sub-regions belong to a same highlight effect; or the first highlight effect displayed in the plurality of sub-regions belong to different highlight effects. This is not limited.

Operation 430: Display a second highlight effect in a selected sub-region in the plurality of sub-regions after the display of the first highlight effect ends.

The second highlight effect is configured for representing an attribute impact of the selected sub-region on the main control virtual object.

For example, the second highlight effect and the first highlight effect are different highlight effects.

In some embodiments, that when the second highlight effect is displayed in the selected sub-region, it represents an attribute impact of the selected sub-region on the main control virtual object includes: There is an attribute impact on the main control virtual object by the selected sub-region; or there is no attribute impact on the main control virtual object by the selected sub-region. The attribute impact includes: an attribute buff effect, an attribute debuff effect, an attribute value does not change, or any combination thereof.

In some embodiments, the plurality of sub-regions includes at least one selected sub-region. When there is a plurality of selected sub-regions, the second highlight effect displayed in each selected sub-region may be the same or different, and each selected sub-region displaying the second highlight effect causes the same/different attribute impact corresponding to the main control virtual object.

In some embodiments, the second highlight effect is displayed in the selected sub-region within a designated time range.

In some embodiments, within the designated time range, when the main control virtual object reaches the selected sub-region, the attribute impact corresponding to the selected sub-region may be obtained; or the main control virtual object stays in the selected sub-region before the display of the second highlight effect ends on the selected sub-region, that is, the attribute impact corresponding to the selected sub-region may be obtained. This is not limited.

In some embodiments, the attribute impact of the selected sub-region in the plurality of sub-regions on the main control virtual object is different from an attribute impact of an unselected sub-region on the main control virtual object.

Operation 440: Display an attribute impact result of the main control virtual object based on a position relationship between the main control virtual object and the selected sub-region.

For example, the attribute impact result is configured for representing a result of the attribute impact on the existence of the main control virtual object based on a position of the current main control virtual object. For example: there is an attribute impact on the main control virtual object by the position of the current main control virtual object; or there is no attribute impact on the main control virtual object by the position of the current main control virtual object.

In some embodiments, when the main control virtual object is located in the selected sub-region, there is a first impact result on the main control virtual object; or when the main control virtual object is located in a designated region of the selected sub-region, there is a first impact result on the main control virtual object.

In some embodiments, when the main control virtual object is located outside the selected sub-region, there is a second impact result on the main control virtual object; or when the main control virtual object is located outside the designated region of the selected sub-region, there is a second impact result on the main control virtual object.

In some embodiments, the position relationship between the main control virtual object and the to-be-selected sub-region is determined based on a designated moment, to determine the attribute impact result. That is, in the current case, the attribute impact result no longer changes after being determined; or the attribute impact result of the main control virtual object is adjusted in real time based on a real-time position relationship between the main control virtual object and the selected sub-region. This is not limited.

In summary, according to the virtual scene effect display method provided in the embodiments of this disclosure, when the main control virtual object is located in the battle region in the virtual scene, the first highlight effect of the plurality of sub-regions is displayed in the battle region. The first highlight effect represents that the sub-region is the to-be-selected candidate region. After the display of the first highlight effect ends, the second highlight effect is displayed on the selected sub-region, to represent the attribute impact of the selected sub-region on the main control virtual object. Finally, the attribute impact result is displayed based on the position relationship between the main control virtual object and the selected sub-region. That is, a player can be prompted for a current candidate region by displaying the first highlight effect, and then the second highlight effect of the selected sub-region is displayed. A region causing an attribute impact can be affected by two highlight effects. In this way, the player cannot know a specific position of the selected sub-region in advance, and diversity of effect display can be improved, thereby improving interactivity of the player in the game process. In addition, a manner of displaying the highlight effect can play a push role for a game process, thereby avoiding a waste of resources of a server.

In an example embodiment, there are two manners of obtaining the selected sub-region. For example, FIG. 5 is a flowchart of a method for displaying an effect in a virtual scene according to an example embodiment of this disclosure. In other words, operation 420 may alternatively be implemented as operation 420a, and operation 430 includes operation 431, operation 432, and operation 433. As shown in FIG. 5, the method includes the following operations.

In this embodiment, there are two different manners of obtaining the selected sub-region: randomly obtaining the selected sub-region or obtaining the selected sub-region based on a preset obtaining condition. In other words, operation 431 and operation 432 are two parallel operations.

Operation 420a: Display a plurality of rounds of first highlight effects in the battle region.

The first highlight effect is displayed for at least one sub-region in a single round.

For example, the round is a number of display times of the first highlight effect. For example, in a first round, the first highlight effect is displayed in a sub-region a, and in a second round, the first highlight effect is displayed in a sub-region b.

In some embodiments, the first highlight effect is displayed in the plurality of sub-regions at least once in the plurality of rounds. In other words, each sub-region in the plurality of sub-regions is the to-be-selected candidate region. Alternatively, the first highlight effect is not displayed in at least one sub-region in the plurality of sub-regions. In other words, some sub-regions in the plurality of sub-regions are not to-be-selected candidate regions. In some embodiments, a display process of the first highlight effect of a single round means that the first highlight effect is displayed in only some sub-regions within the round. For example, currently, the plurality of sub-regions includes a sub-region a, a region b, and a region c. In a first round, the first highlight effect is displayed for the sub-region a. In a second round, the first highlight effect is simultaneously displayed for the sub-region b and the sub-region c. In a third round, the first highlight effect is displayed sequentially for the sub-region a and the sub-region c. In other words, in each round, the first highlight effect is displayed in at least one sub-region.

In some embodiments, the first highlight effect displayed in each round is a same highlight effect/different highlight effects. In addition, some sub-regions in which the first highlight effect is displayed in each round are the same/different. In other words, in this case, a display manner of the first highlight effect is implemented as cyclical display. This is not limited.

In some embodiments, a method for determining the round includes at least one of the following methods.

1. Determine a round of displaying the first highlight effect based on a designated display order. For example, the first highlight effect is displayed for the sub-regions in sequence in a clockwise/counterclockwise manner, and a process of displaying the first highlight effect once on the sub-regions in sequence is used as a round of the displaying.

2. Determine a round of the first highlight effect based on a number of display times. For example: in a single round, the first highlight effect is displayed in some sub-regions for a same number of times.

3. Determine a round of displaying the first highlight effect based on a designated arrangement order. For example: the first highlight effects in some sub-regions are displayed from far to near based on distances to the main control virtual object, to display a first image effect in a single round.

The foregoing process describes the content of displaying a plurality of rounds of first highlight effects. Through a round display status of the first highlight effect, the first highlight effect can be presented more flexibly from two dimensions: time and a number of times, to avoid a problem that an effect is not apparent as a result of displaying the first highlight effect once. The first highlight effect is displayed for a number of times, so that a difference between the first highlight effect and a conventional situation can be enhanced, and the to-be-selected candidate region is highlighted. In addition, the first highlight effect is displayed on the at least one sub-region in a single round. Based on a plurality of rounds, differential presentations between the plurality of sub-regions can be presented more intuitively, which enhances expression forms between different sub-regions.

The foregoing method for determining the round is only illustrative example. This is not limited in this embodiment of this disclosure.

In some embodiments, there is a delay moment between rounds. In other words, there is a time period without any highlight display from after the display of the first highlight effect of some sub-regions in a first round ends to before the display of the first highlight effect of some sub-regions in a second round starts; or there is no delay moment between rounds. This is not limited.

In this embodiment, through the plurality of rounds of first highlight effects for the plurality of sub-regions, different sub-regions can be determined as to-be-selected candidate regions in the plurality of rounds, so that the player cannot immediately determine a specific position of a subsequently selected sub-region, thereby enabling the player to develop a more complete game strategy, and improving game interactivity of the player.

Operation 431: Randomly obtain a selected sub-region from the plurality of sub-regions after the display of the first highlight effect ends.

In some embodiments, after the display of the first highlight effect ends, the selected sub-region is randomly obtained from the plurality of sub-regions.

In some embodiments, a method of randomly obtaining the selected sub-region includes at least one of the following random selection methods:

1. Randomly obtain the selected sub-region by using a random number selection method. To be specific, a plurality of sub-regions is respectively numbered, different numbers respectively corresponding to the plurality of sub-regions are inputted into a pre-trained random number generator, at least one number is randomly outputted, and a sub-region corresponding to the number is used as the selected sub-region.

2. Obtain the selected sub-region by using an equidistant random sampling method. To be specific, the plurality of sub-regions is respectively numbered, each sub-region corresponds to a different number, and a plurality of numbers are arranged in sequence in random order to obtain a number sequence, an extraction interval is set, a number corresponding to a sequence position is extracted in a number sequence based on the extraction interval, and a sub-region corresponding to the number is used as the selected sub-region.

3. Obtain the selected sub-region by using a classification random sampling method. The plurality of sub-regions is classified based on a display number of displaying the first highlight effect respectively, and a same type includes sub-regions with a same display number, so that at least one sub-region in each type is randomly selected as the selected sub-region. The foregoing manner of randomly obtaining the selected sub-region is only illustrative example. This is not limited in this embodiment of this disclosure.

In some embodiments, the selected sub-region belongs to a sub-region on which the first highlight effect has been displayed; or the selected sub-region belongs to a sub-region on which the first highlight effect has not been displayed. This is not limited.

In some embodiments, a selected sub-region is randomly obtained from the plurality of sub-regions; or a plurality of selected sub-regions are randomly obtained from the plurality of sub-regions.

In this embodiment, the selected sub-region is randomly obtained from the plurality of sub-regions, the player cannot predict a specific position of the selected sub-region in advance, so that the player needs to specify a relevant movement strategy to control the main control virtual object to move in the virtual scene, to determine a subsequent attribute impact on the main control virtual object, which enhances interactivity of the player and improves efficiency and diversity of effect display.

Operation 432: Obtain the selected sub-region from the plurality of sub-regions based on a preset obtaining condition after the display of the first highlight effect ends.

In some embodiments, after the display of the first highlight effect ends, a sub-region satisfying a preset condition is obtained from the plurality of sub-regions based on the preset obtaining condition as the selected sub-region.

In some embodiments, the selected sub-region belongs to a sub-region on which the first highlight effect has been displayed; or the selected sub-region belongs to a sub-region on which the first highlight effect has not been displayed. This is not limited.

In some embodiments, the preset obtaining condition includes at least one of the following conditions:
1. Select, in a display process of the first highlight effect, a sub-region with the smallest dwell time of the main control virtual object as a selected sub-region;
2. Select, in a display process of the first highlight effect, a sub-region whose number of display times reaching a designated number threshold as a selected sub-region; or
3. Select the last at least one sub-region on which the first highlight effect is displayed as a selected sub-region.

Currently, the condition content of the preset obtaining condition is only illustrative example. This is not limited in this embodiment of this disclosure.

In this embodiment, based on the preset obtaining condition, the selected sub-region is determined from the plurality of regions, so that the player can move in time based on the preset obtaining condition, thereby affecting the attribute impact subsequently generated, which can have a prompt effect on the player, so that the player can improve accuracy of a movement position, shorten game duration, and reduce data overheads of the server.

The foregoing content describes a method for determining the selected sub-region. The selected sub-region is used as a sub-region on which the second highlight effect is displayed, and can be distinguished from a to-be-selected candidate region on which the first highlight effect is displayed. When the selected sub-region is obtained in a random obtaining manner, a limitation of determining the selected sub-region in a purely manual selection manner can be avoided, and obtaining flexibility of the selected sub-region can be improved. In addition, the selected sub-region may also be determined from the plurality of sub-regions in a more targeted manner based on the preset obtaining condition. Through a process of determining the selected sub-region, it is beneficial to analyze an attribute status between the selected sub-region and the main control virtual object, so as to enhance an expression meaning of the second highlight effect and improve a region impact status of the player in determining the selected sub-region based on the second highlight effect.

In an example process of operation 431 and operation 432, one of the operations may be arbitrarily selected to obtain the selected sub-region; or the selected sub-region may be first determined through operation 432. If a process of obtaining the selected sub-region cannot be implemented through operation 432, operation 431 is used to obtain the selected sub-region. This is not limited.

Operation 433: Display a second highlight effect in the selected sub-region.

For example, after the selected sub-region is obtained, the second highlight effect is displayed in the selected sub-region.

When the plurality of selected sub-regions is obtained, in some embodiments, the second highlight effect is displayed in the plurality of selected sub-regions at the same time; or referring to a display manner of the first highlight effect, the second highlight effect is displayed in the plurality of selected sub-regions. The second highlight effect of some selected sub-regions in the plurality of selected sub-regions is displayed for a single round. This is not limited.

In some embodiments, the second highlight effect is displayed on the selected sub-region within a preset time range.

For example, a time range is preset, and the second highlight effect is displayed in the selected sub-region within the preset time range.

In some embodiments, a sum of time ranges corresponding to the second highlight effect is displayed for all the selected sub-regions in the preset time range, for example, the plurality of selected sub-regions includes a region a and a region b. In this case, the preset time range refers to a sum of display duration during which the region a and the region b display the second highlight effect simultaneously/in sequence. Alternatively, the second highlight effect is displayed for a single selected sub-region in the preset time range, for example, the plurality of selected sub-regions includes a region 1 and a region 2. In this case, a preset time range 1 is display duration for displaying the second highlight effect for the region 1, and a preset time range 2 is display duration for displaying the second highlight effect for the region 2.

In addition, when display duration of the second highlight effects respectively corresponding to the plurality of selected sub-regions are the same, the preset time ranges respectively corresponding to the plurality of selected sub-regions are the same (that is, the preset time range 1 is the same as the preset time range 2); otherwise, the preset time ranges are different (that is, the preset time range 1 is different from the preset time range 2).

The foregoing content describes a display status of the second highlight effect. The display duration of the second highlight effect is limited by using the preset time range, to avoid a problem that the second highlight effect indicates unclear meaning as a result of displaying the second highlight effect for a long time, and can avoid a resource consumption amount of displaying the second highlight effect for a long time, thereby reducing an occupation of a resource amount.

In some embodiments, the player cannot sense the preset time range of the second highlight effect; or a preset time range corresponding to the second highlight effect is displayed in the terminal. This is not limited.

In this embodiment, the preset time range is set for the display duration of the second highlight effect, so that the player needs to reach/move away from the selected sub-region within the preset time range, which prompts the player to improve efficiency of controlling the movement of the main control virtual object, thereby shortening the game time and saving data overheads of the server, making the player have a sense of tension in a game process, and improving a game experience and fun of the player.

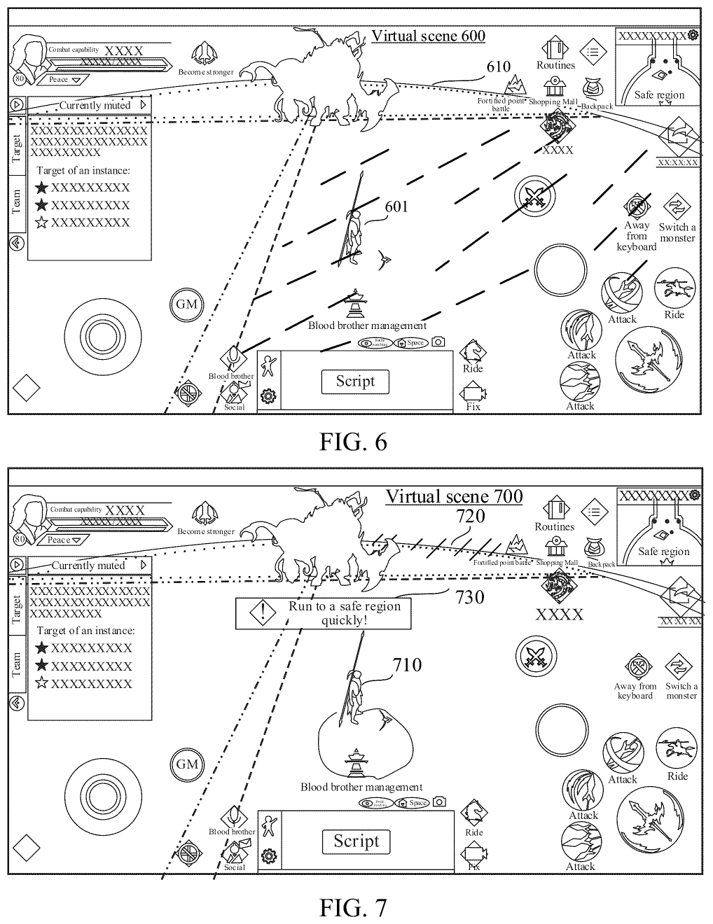

For example, FIG. 6 is a schematic diagram of a second highlight display effect according to an example embodiment of this disclosure. As shown in FIG. 6, a virtual scene 600 is currently displayed. The virtual scene 600 includes a main control virtual object 601 located in a battle region 610. After the display of the first highlight effect ends, a second highlight effect 611 (represented in FIG. 6 by using an oblique dashed line as an example) is displayed in a selected sub-region, and the second highlight effect 611 is displayed within a preset time range.

In some embodiments, because there is the preset time range for the second highlight effect, in a process of displaying the second highlight effect, the region prompt information exists. In other words, the region prompt information is displayed, and the region prompt information is configured for prompting the main control virtual object to move to the selected sub-region within the preset time range.

For example, in the process of displaying the second highlight effect, region prompt information is displayed, and is configured for prompting the player that the main control virtual object needs to be controlled to move to the selected sub-region within the preset time range. The prompt information is configured for performing region reminding on the player.

In some embodiments, in the process of displaying the second highlight effect, the region prompt information is continuously displayed, and display duration of the region prompt information is consistent with that of the second highlight effect. In other words, regardless of whether the main control virtual object reaches the selected sub-region, the region prompt information is continuously displayed. Alternatively, in a display process of the second highlight effect, when the main control virtual object has not been located in the selected sub-region, the region prompt information is displayed. When the main control virtual object has been located in the selected sub-region, the display of the region prompt information is hidden. Alternatively, there is a delay between the end of the first highlight effect and the display of the second highlight effect in the selected sub-region. In this case, the region prompt information is displayed, and is configured for reminding the player before the second highlight effect starts to be displayed in the selected sub-region. This is not limited.

For example, FIG. 7 is a schematic diagram of region prompt information according to an example embodiment of this disclosure. As shown in FIG. 7, a virtual scene 700 is currently displayed. The virtual scene 700 includes a main control virtual object 710 located in a battle region. In this case, when the main control virtual object 710 has not moved to a selected sub-region 720, region prompt information 730 “Run to a safe region quickly!” is currently displayed in the virtual scene 700.

In this embodiment, the region prompt information is displayed, so that the player can be reminded that the main control virtual object currently needs to be controlled to move to the selected sub-region. Therefore, a damage suffered by the main control virtual object because the main control virtual object is located outside the selected sub-region is avoided to some extent, and a survival probability of the main control virtual object in the game is improved. In addition, the region prompt information plays a prompt role, which can also improve message indication efficiency, so that the player can control the main control virtual object to move to the selected sub-region more quickly, to avoid an unnecessary movement process, thereby reducing computing overheads of the server.

Operation 440: Display an attribute impact result of the main control virtual object based on a position relationship between the main control virtual object and the selected sub-region.

For example, after the display of the second highlight effect of the selected sub-region ends, the attribute impact result corresponding to the main control virtual object is displayed based on the position relationship between the main control virtual object and the selected sub-region.

In some embodiments, a manner for determining the attribute impact result includes at least one of the following manners:

1. Obtain an object position of the main control virtual object at a current moment when the second highlight effect ends, and determine an attribute impact result based on the object position at the current moment. That is, a current attribute impact result is only affected by a position of the main control virtual object at a single moment, and even if the main control virtual object changes the position subsequently, the attribute impact result is not affected.

2. After the second highlight effect ends, the attribute impact result corresponding to the main control virtual object is displayed in real time based on a real-time position of the main control virtual object in the virtual scene. That is, the current attribute impact result continuously changes based on the real-time position of the main control virtual object.

The foregoing manner for determining the attribute impact result is only illustrative example. This is not limited in this embodiment of this disclosure.

In this embodiment, the attribute impact result is divided into a first impact result corresponding to being within the selected sub-region, and a second impact result corresponding to being located outside the selected sub-region.

The first impact result is different from the second impact result.

In some embodiments, an object position of the main control virtual object is obtained; and a first impact result of the main control virtual object is displayed in response to the object position being within the selected sub-region.

In this embodiment, when the second highlight effect ends, the object position of the main control virtual object at the current moment is obtained. If the object position at the moment of the main control virtual object is located in the selected sub-region, the first impact result of the main control virtual object is displayed, where the first impact result refers to that the main control virtual object is not affected by the attribute debuff effect.

In some embodiments, the second impact result of the main control virtual object is displayed in response to the object position being located outside the selected sub-region.

In this embodiment, when the second highlight effect ends, the object position of the main control virtual object at the current moment is obtained. If the object position at the moment of the main control virtual object is located outside the selected sub-region, the second impact result of the main control virtual object is displayed, where the second impact result refers to that the main control virtual object is affected by the attribute debuff effect.

In the foregoing, different impact results are differentially displayed as the attribute impact result of the main control virtual object based on a relative position relationship between the object position and the selected sub-region. When the object position is located in the selected sub-region, the first impact result is displayed as the attribute impact result; and when the object position is located outside the selected sub-region, the second impact result is displayed as the attribute impact result. Because the first impact result is different from the second impact result, a position relationship between the selected sub-region and the main control virtual object can be presented more intuitively by using a display process of different impact results, to present an attribute impact status of the selected sub-region on the main control virtual object more intuitively, which is convenient for the player to perform a subsequent game process based on the displayed attribute impact result, and improves human-computer interaction efficiency in the game process.

In this embodiment, the selected sub-region located in and the selected sub-region located outside respectively correspond to different attribute impact results, the player can control the main control virtual object to move into the selected sub-region in time, thereby improving efficiency of effect indication, and also increasing diversity of playing.

In summary, according to the virtual scene effect display method provided in the embodiments of this disclosure, when the main control virtual object is located in the battle region in the virtual scene, the first highlight effect of the plurality of sub-regions is displayed in the battle region. The first highlight effect represents that the sub-region is the to-be-selected candidate region. After the display of the first highlight effect ends, the second highlight effect is displayed on the selected sub-region, to represent the attribute impact of the selected sub-region on the main control virtual object. Finally, the attribute impact result is displayed based on the position relationship between the main control virtual object and the selected sub-region. That is, a player can be prompted for a current candidate region by displaying the first highlight effect, and then the second highlight effect of the selected sub-region is displayed. A region causing an attribute impact can be affected by two highlight effects. In this way, the player cannot know a specific position of the selected sub-region in advance, and diversity of effect display can be improved, thereby improving interactivity of the player in the game process. In addition, a manner of displaying the highlight effect can play a push role for a game process, thereby avoiding a waste of resources of a server.

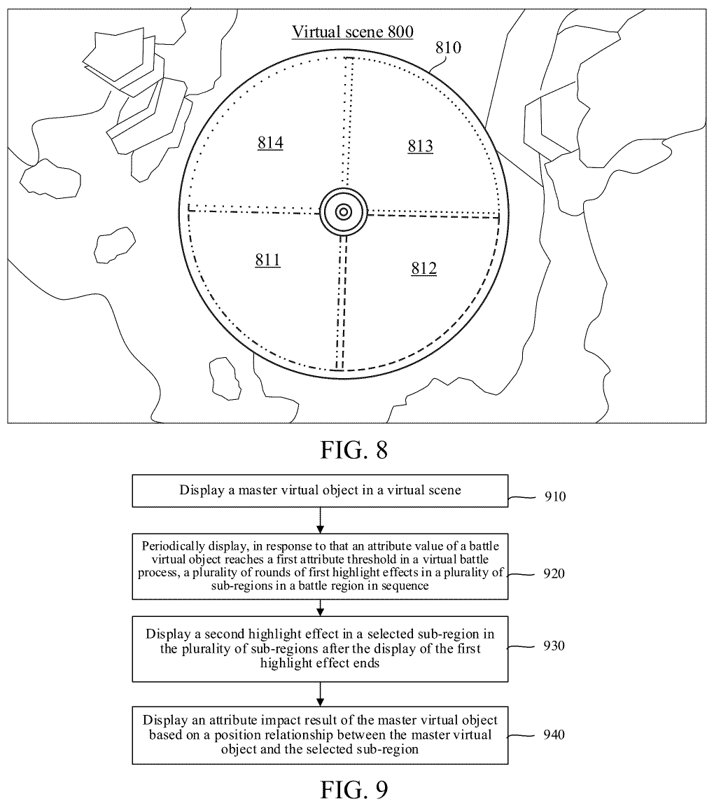

In an embodiment, an example in which the first highlight effect is implemented as a roulette effect is configured for description. First, the roulette effect is described. For example, FIG. 8 is a schematic diagram of a roulette effect according to an example embodiment of this disclosure. As shown in FIG. 8, a virtual scene 800 is currently displayed. The virtual scene 800 includes a circular battle region 810. The circular battle region 810 includes a plurality of sub-regions, namely a sub-region 811, a sub-region 812, a sub-region 813, and a sub-region 814. Each sub-region is implemented as a sector sub-region. That is, a battle region is a circular roulette region, and the circular roulette region includes a plurality of sector sub-regions.

The following describes a method for displaying an effect in a virtual scene provided in this disclosure by using the foregoing sub-region in FIG. 8. The application in a role-playing game is used as an example. For example, FIG. 9 is a flowchart of a method for displaying an effect in a virtual scene according to an example embodiment of this disclosure. As shown in FIG. 9, the method includes the following operations.

Operation 910: Display a main control virtual object in a virtual scene.

The main control virtual object is located in a battle region in the virtual scene, and the battle region includes a plurality of sub-regions.

In some embodiments, the virtual scene further includes a battle virtual object, and the battle virtual object performs a virtual battle with the main control virtual object in the battle region.

For example, the virtual scene includes not only a main control virtual object controlled by a terminal account logged in to the terminal, but also the battle virtual object that performs a virtual battle with the main control virtual object.

In some embodiments, the battle virtual object is a virtual object controlled by another account; or the battle virtual object is a virtual object preset by the server. To be specific, in this case, the battle virtual object belongs to a non-player character (NPC). This is not limited.

In this embodiment, an example in which the battle virtual object is implemented as a defending monster (BOSS) is configured for description.

In this embodiment, the battle region is implemented as the circular battle region described in FIG. 8 above, and the plurality of sub-regions included in the battle region are implemented as the sector sub-regions described in FIG. 8 above.

In this embodiment, a scene is applied in a process of performing a virtual battle with the battle virtual object, so that the player can display the highlight effect in a subsequent sub-region in a battle process, and the player can add different game mechanics in the battle process, which increases a game difficulty to a certain extent, improves diversity of battle manners, thereby improving game fun of the player.

Operation 920: Periodically display, in response to an attribute value of the battle virtual object reaching a first attribute threshold in a process of the virtual battle, a plurality of rounds of first highlight effects on a plurality of sub-regions in the battle region in sequence.

For example, in a battle process between the current main control virtual object and the battle virtual object in the battle region, when an attribute value of the battle virtual object reaches the first attribute threshold, a display mechanism of the first highlight effect is triggered.

In some embodiments, the foregoing display mechanism of the first highlight effect may be implemented as a skill mechanism carried by the battle virtual object; or the foregoing display mechanism of the first highlight effect may be implemented as a battle mechanism generated in a process of performing a virtual battle in the battle region. This is not limited.

The foregoing content introduces the battle virtual object that performs the virtual battle with the main control virtual object. The content of displaying the first highlight effect in the plurality of sub-regions is described through the attribute value of the battle virtual object. By means of the attribute value of the battle virtual object, an impact status of the attribute value of the battle virtual object on the to-be-selected candidate region is fully considered, and on a condition that the attribute value of the battle virtual object reaches the first attribute threshold, the first highlight effect is periodically presented, to more intuitively emphasize the attribute impact that may be caused by the battle virtual object to the main control virtual object, thereby improving a degree of attention of the player to the game and improving fun of the player in a game process.

In this embodiment, when the attribute value (a health point) of the battle virtual object (BOSS) in a process of the virtual battle reaches 80% or less, the display mechanism of the first highlight effect is triggered.

In some embodiments, after the display mechanism of the first highlight effect is triggered, the terminal sends a first effect instruction to the server for obtaining the first rendering data, so that the first highlight effect is displayed based on the first rendering data, that is, the first rendering data is obtained; effect rendering is performed on the plurality of sub-regions based on the first rendering data, to obtain first rendering results respectively corresponding to the plurality of sub-regions; and the plurality of rounds of first highlight effects are displayed based on the first rendering result.

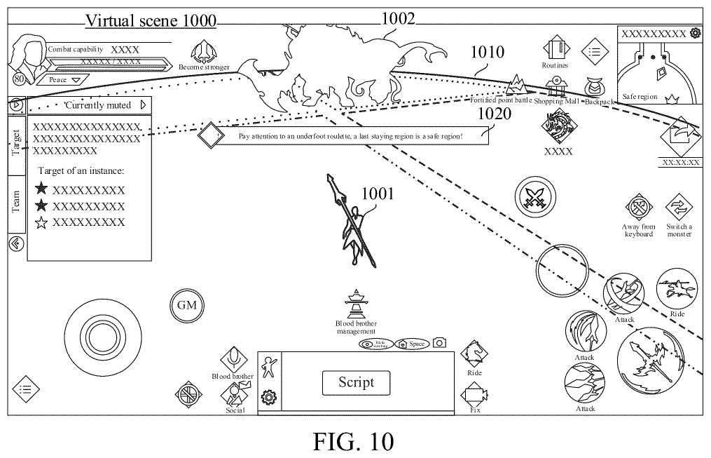

For example, FIG. 10 is a schematic diagram of enabling a highlight display mechanism according to an example embodiment of this disclosure. As shown in FIG. 10, a virtual scene 1000 is currently displayed. The virtual scene 1000 includes a main control virtual object 1001 and a battle virtual object 1002 that are in a battle region 1010. When a health point of the battle virtual object 1002 falls by 80% in a process of the virtual battle between the main control virtual object 1001 and the battle virtual object 1002, a highlight display mechanism is triggered. That is, currently, the battle region 1010 includes four sector sub-regions (which are divided by dashed-dotted lines). In addition, a mechanism enabled prompt 1020 is displayed in a virtual scene picture. The mechanism enabled prompt 1020 is configured for indicating that a plurality of sub-regions displays a first highlight effect and a second highlight effect.

For example, in the plurality of sub-regions included in the battle region, each sub-region is pre-stored with a corresponding data file. The data file includes first rendering data and second rendering data corresponding to the sub-region. The first rendering data is configured for displaying the first highlight effect, and the second rendering data is configured for displaying the second highlight effect. This is described in detail in the following embodiments.

For example, after obtaining the first rendering data, the terminal renders a corresponding sub-region based on the first rendering data, to obtain a first rendering result, and displays the first highlight effect based on the first rendering result.

The foregoing process describes content of the first highlight effect obtained through rendering based on the first rendering data. Effect rendering is performed on the plurality of sub-regions through the first rendering data, to obtain first rendering results respectively corresponding to the plurality of sub-regions, and the first rendering result is used as an application result of the first rendering data applied to the plurality of sub-regions. Therefore, a rendering status of the first highlight effect can be presented more intuitively. On a condition that the first highlight effect of the plurality of sub-regions in a single round are displayed with a plurality of first rendering results, it is also convenient for the player to more clearly learn, based on the first highlight effect, the plurality of sub-regions that are to-be-selected candidate regions in a current round, and it is helpful for the player to move to the plurality of sub-regions that display the first highlight effect, thereby improving human-computer interaction efficiency through the display of the highlight effect.

In some embodiments, a manner in which the plurality of sub-regions display the first highlight effect is implemented as periodically displaying a plurality of rounds of first highlight effects in the plurality of sub-regions in sequence.

The “periodically” refers to starting from the first round, after a display process of a designated number of rounds of first highlight effects is passed, the display starts again from the first round in a cyclical manner.

“Displaying in sequence” means that the sub-regions in the battle region are displayed in sequence based on arrangement. That is, in this embodiment, a manner of displaying the first highlight effects of the plurality of sub-regions may be implemented as a roulette display manner. The roulette display manner is implemented to display each roulette sub-region in sequence in a designated direction (clockwise/counterclockwise) starting from a designated region.

In this embodiment, in a single round, a sub-region in the plurality of sub-regions is used as a start region, and the first highlight effect is displayed in sequence one by one in a clockwise order (that is, some sub-regions are all sub-regions). After the last sub-region displays the first highlight effect, it is considered that the first highlight effect is displayed for the plurality of sub-regions in the single round. Then, a second round, a third round, . . . , are cyclically displayed in sequence.

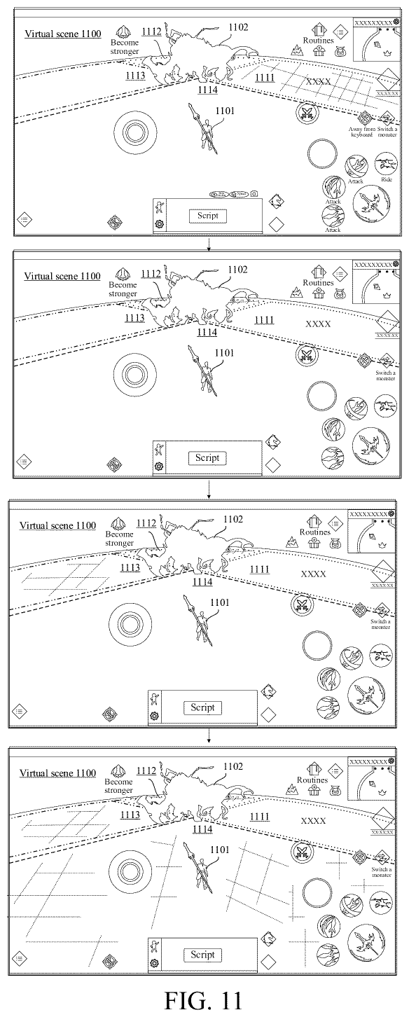

For example, FIG. 11 is a schematic diagram of displaying a first highlight effect in a single round according to an example embodiment of this disclosure. As shown in FIG. 11, a virtual scene 1100 is currently displayed, where the virtual scene 1100 includes a main control virtual object 1101 and a battle virtual object 1102. The virtual scene 1100 includes a sub-region 1111, a sub-region 1112, a sub-region 1113, and a sub-region 1114. Currently, in a single round display process, first, the sub-region 1111 is used as a display start point, and a first highlight effect is displayed in the sub-region 1111 (FIG. 11 is illustrated by a virtual grid representing that the first highlight effect is currently displayed in the sub-region). After the display of the sub-region 1111 ends, the first highlight effect is displayed in the sub-region 1112, the first highlight effect is displayed in the sub-region 1113, and the first highlight effect is displayed in the sub-region 1114 in sequence. After the display of the first highlight effect in the sub-region 1114 ends, a process of displaying the first highlight effect in the round ends, and then the display may continue to start from the sub-region 1111.

In this embodiment, the display manner of the first highlight effect is implemented as a roulette display manner, the player can learn of a current game mechanism at an extremely low education cost, thereby improving efficiency of effect display, and greatly reducing cost overheads of effect display.

In some embodiments, in a single round, some sub-regions are determined based on a skill casting direction of the battle virtual object, a display position of the sub-regions being consistent with the skill casting direction; and the first highlight effect is displayed in the sub-regions.

In an example, the display process of the first highlight effect is related to the skill casting direction of the battle virtual object. To be specific, when the battle virtual object casts a skill in a certain direction in a process of the virtual battle, the first highlight effect is displayed in a sub-region corresponding to the direction.

In this embodiment, the display process of the first highlight effect is related to the direction in which the battle virtual object casts the skill, the skill casting direction of the battle virtual object is determined, and an impact status of the skill casting direction of the battle virtual object on the to-be-selected candidate region is fully considered, so that some sub-regions with the same display position are determined based on the skill casting direction. In this way, the first highlight effect is displayed in the sub-regions, to more intuitively emphasize the attribute impact that may be caused by a skill casting process of the battle virtual object on the main control virtual object, so that the player can move in time based on the first highlight effect in a process of controlling the main control virtual object to perform the virtual battle, which improves efficiency and directionality of effect display.

Operation 930: Display a second highlight effect in a selected sub-region in the plurality of sub-regions after the display of the first highlight effect ends.

The second highlight effect is configured for representing an attribute impact on the main control virtual object.

The content of the second highlight effect in operation 930 has been described in detail in the foregoing embodiments. Details are not described herein again.

Operation 940: Display an attribute impact result of the main control virtual object based on a position relationship between the main control virtual object and the selected sub-region.

In this embodiment, before the display of the second highlight effect ends, the player needs to control the main control virtual object to move into the selected sub-region. When the display of the second highlight effect ends, if the main control virtual object is located in the selected sub-region, the main control virtual object is not affected by the attribute debuff effect. If the main control virtual object is located outside the selected sub-region, the main control virtual object is affected by the attribute debuff effect.

In this embodiment, the selected sub-region is used as the safe region.

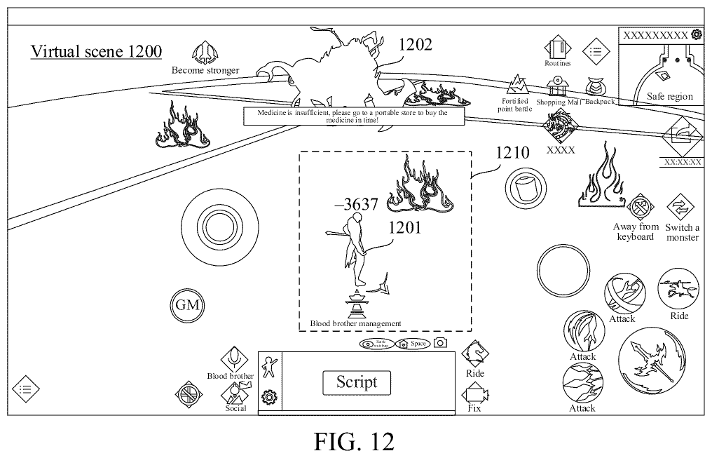

For example, FIG. 12 is a schematic diagram of an attribute debuff effect according to an example embodiment of this disclosure. As shown in FIG. 12, a virtual scene 1200 is currently displayed. The virtual scene 1200 includes a main control virtual object 1201 and a battle virtual object 1202. Currently, when the display of a second highlight effect ends, the main control virtual object 1201 is not located in the selected sub-region. Therefore, an attribute debuff effect picture 1210 is currently displayed. The attribute debuff effect picture 1210 includes a display of a decrease amount (−3637) of a health point of the main control virtual object 1201.

In some embodiments, the display of the second highlight effect is canceled in response to the attribute value of the battle virtual object reaching a second attribute threshold before the display of the second highlight effect ends.

In an example, if the main control virtual object performs the virtual battle with the battle virtual object before the display of the second highlight effect ends, the attribute value of the battle virtual object reaches the second attribute threshold (for example, a health point is 0), the second highlight effect is no longer displayed in the current virtual scene, that is, there is no attribute impact on the main control virtual object.

In the foregoing content, the attribute value of the battle virtual object is determined, the attribute value is compared with the second attribute threshold, and the first highlight effect is periodically presented on a condition that the attribute value of the battle virtual object reaches the first attribute threshold, to more intuitively emphasize the attribute impact that may be caused by the battle virtual object to the main control virtual object, thereby improving a degree of attention of the player to the game and improving fun of the player in the game process.

In an example described in FIG. 8, when the battle region is implemented as the circular roulette region, the plurality of sub-regions is implemented as the plurality of sector sub-regions. An angular division relationship represented by the sector sub-region is used to divide the battle region more flexibly, to avoid a problem of a large difference in region division caused by dividing different annular regions by means of a difference between circular points. The correlation between the plurality of sub-regions is enhanced by the sector sub-region, which is also conducive to presenting changes that a highlight special effect more intuitively and harmoniously.

In this embodiment, there is a certain cool down time between the end of the second highlight effect and the display of the attribute impact result. In this case, because there is no process of displaying the highlight effect, the mood of the player can no longer fluctuate as the display of the highlight effect, and a psychological fluctuation curve is gentle. Therefore, a game tempo is adjusted, and a mood of the player fluctuates forward in an entire battle process.

In summary, according to the virtual scene effect display method provided in the embodiments of this disclosure, when the main control virtual object is located in the battle region in the virtual scene, the first highlight effect of the plurality of sub-regions is displayed in the battle region. The first highlight effect represents that the sub-region is the to-be-selected candidate region. After the display of the first highlight effect ends, the second highlight effect is displayed on the selected sub-region, to represent the attribute impact of the selected sub-region on the main control virtual object. Finally, the attribute impact result is displayed based on the position relationship between the main control virtual object and the selected sub-region. That is, a player can be prompted for a current candidate region by displaying the first highlight effect, and then the second highlight effect of the selected sub-region is displayed. A region causing an attribute impact can be affected by two highlight effects. In this way, the player cannot know a specific position of the selected sub-region in advance, and diversity of effect display can be improved, thereby improving interactivity of the player in the game process. In addition, a manner of displaying the highlight effect can play a push role for a game process, thereby avoiding a waste of resources of a server.

In an embodiment, the virtual scene effect display method provided in this disclosure is implemented by binding special effect data displayed by the terminal to a virtual object in the game. In this embodiment, each sub-region corresponds to a designated virtual object. The virtual object may be referred to as a “stealth monster”, that is, the player cannot sense the existence of a “stealth monster” in a process of performing the virtual battle. A virtual object corresponding to each sub-region is equivalent to a data file stored corresponding to the sub-region. When a mechanism is triggered in the sub-region to perform content display on the terminal, a skill corresponding to the display content is cast for the virtual object corresponding to the sub-region. For example: effect display (a first highlight effect/a second highlight effect), a safety warning (a region prompt message/a mechanism enabled prompt), and a debuff animation (a display animation corresponding to an attribute debuff effect) respectively correspond to different skills of the virtual object.

In this embodiment, different display contents in the single sub-region are implemented as skills bound to one virtual object, so that different contents can be presented in a manner of controlling the virtual object, which avoids overhead burden on a computer caused by frequently reading a large amount of data from a data file.

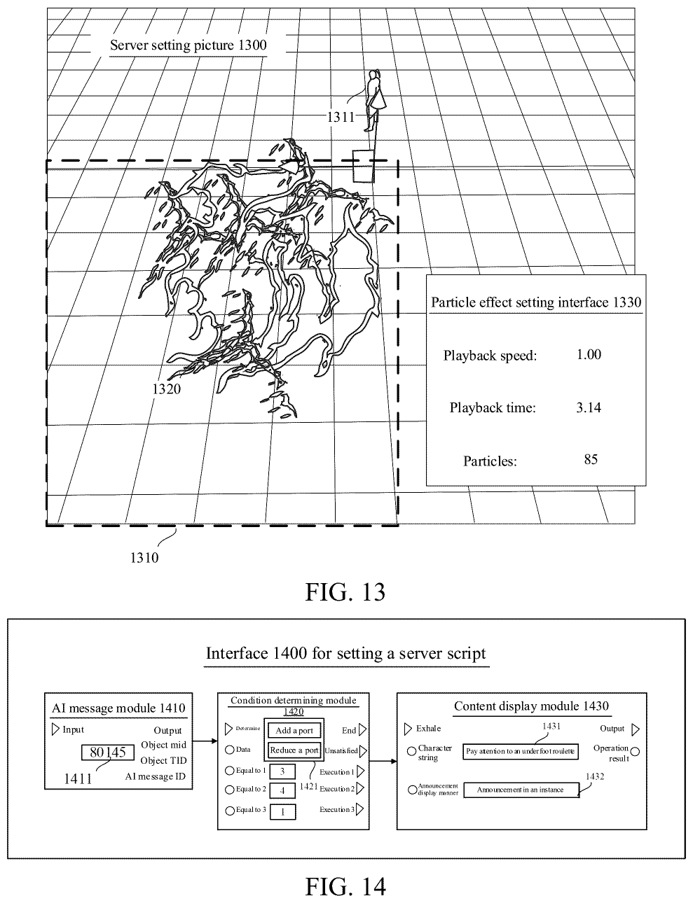

For example, FIG. 13 is a schematic diagram of skill casting of a virtual object according to an example embodiment of this disclosure. As shown in FIG. 13, a server setting picture 1300 corresponding to a virtual scene is currently displayed. The virtual scene includes a sub-region 1310 and a virtual object 1311 corresponding to the sub-region 1310. A debuff animation 1320 (which is implemented as a virtual flame damage animation for generating an attribute debuff effect on a main control virtual object in a process of displaying a flame animation) is currently displayed in the virtual scene. The debuff animation 1320 is a debuff effect skill cast by the virtual object 1311 in the sub-region 1310. In addition, the server setting picture 1300 further includes a particle effect setting interface 1330, and the particle effect setting interface 1330 is configured to adjust a display status parameter of the virtual object. The display status parameter includes a playback speed, playback time, and particles.

In this embodiment, the virtual object is controlled by character artificial intelligence (AI), and each skill of the virtual object has a corresponding cool down time (for example: there is a cool down time between the end of the display of the first highlight effect and the start of the display of the second highlight effect, the first highlight effect corresponds to a first effect display skill of the virtual object, and the second highlight effect corresponds to a second highlight effect display skill of the virtual object). After the cool down time of a previous skill ends, an instruction is sent to the server script. After the server script receives the instruction, a subsequent mechanism is enabled and executed based on the cooling.

For example, FIG. 14 is a schematic diagram of instruction transmission according to an example embodiment of this disclosure. As shown in FIG. 14, an interface 1400 for setting a server script is currently displayed. The interface 1400 for setting a server script includes an AI message module 1410, a condition determining module 1420, and a content display module 1430. The AI message module 1410 is configured to determine a virtual object corresponding to an instruction currently transmitted to the server script, that is, indicate a sub-region for which the server script is currently set. The AI message module 1410 includes identity information 1411 of the virtual object. The condition determining module 1420 is configured to: input corresponding data based on the instruction currently inputted into the server script, and determine an execution behavior corresponding to the data through a data port 1421 in the condition determining module 1420. For example: Data “1” is inputted, and a corresponding execution behavior 1 is learned through the data port 1421. The content display module 1430 is configured to: determine text content of a display message displayed in a virtual scene picture, and select, by text content “Attention to an underfoot roulette” in a string input box 1431, a corresponding display manner “Copy announcement” based on a display manner selection control 1432, to generate an announcement message “Attention to a roulette” and finally output the announcement message.

After a highlight mechanism starts, the server first determines a sub-region as a start point, selects a virtual object corresponding to the sub-region, and adjusts a birth direction and birth coordinates of the virtual object. The birth direction and birth coordinates determine a subsequent direction in which the virtual object casts a skill. That is, an effect/content/animation corresponding to the skill is displayed on the terminal. The birth direction and birth coordinates are configured for subsequently controlling, in different sub-regions, virtual objects respectively corresponding to the different sub-regions to cast different skills in sub-regions respectively corresponding to the virtual objects.

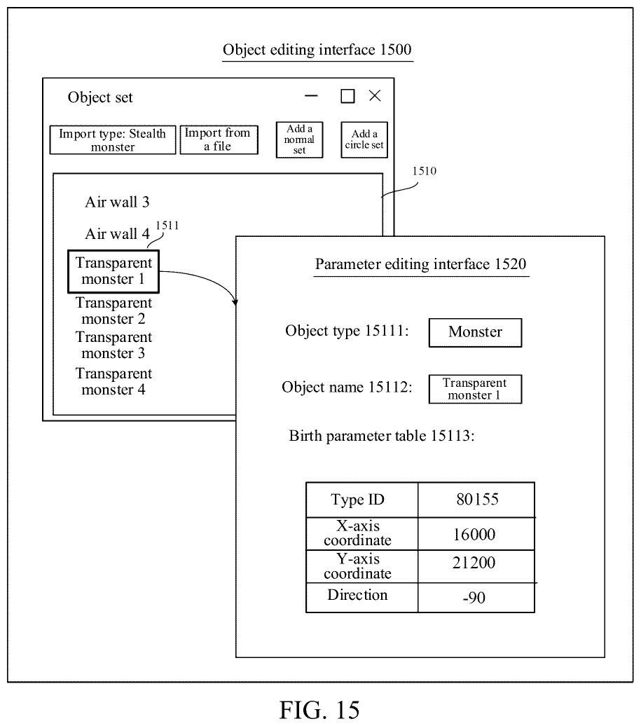

For example, FIG. 15 is an editing interface of a virtual object according to an example embodiment of this disclosure. As shown in FIG. 15, an object editing interface 1500 is currently displayed, including a virtual object list 1510 is displayed. When a designated virtual object 1511 (a transparent monster 1) is selected, a parameter editing interface 1520 corresponding to the virtual object 1511 is displayed. The parameter editing interface 1520 includes an object type 15111, an object name 15112, and a birth parameter table 15113 corresponding to the virtual object 1511.

When the server determines and casts a designated skill corresponding to the virtual object based on an inputted instruction, the terminal displays special effect performance (effect/content/animation display) corresponding to the designated skill. After the selected sub-region is determined, settlement is performed based on a short delay. The server determines an object position at which the main control virtual object is currently located. When the main control virtual object is located outside the selected sub-region, a skill that casts force damage to the main control virtual object causes a health point to exceed i. In addition, the terminal indicates that the main control virtual object is located in a flame region, and displays a debuff effect number.

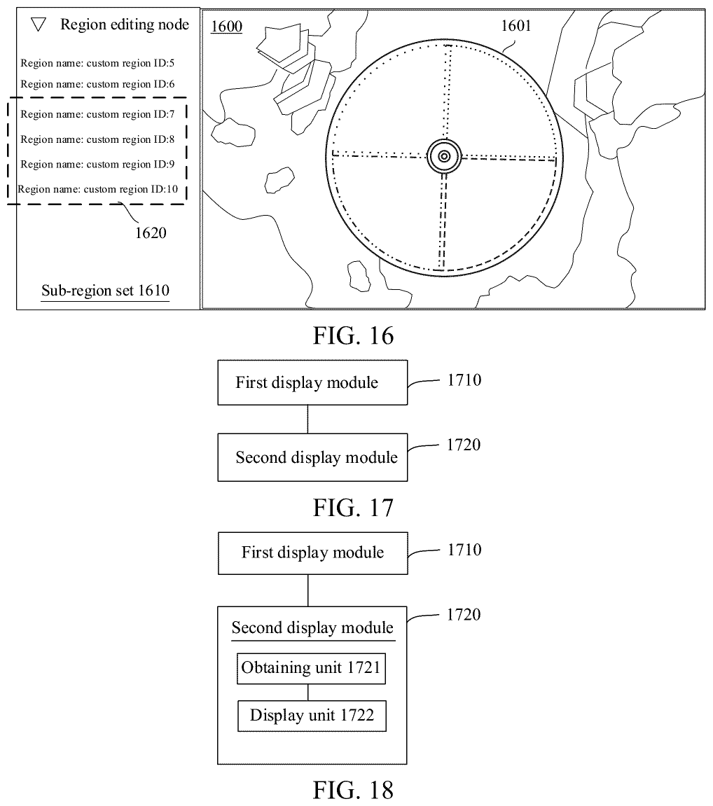

The server selects a plurality of sub-regions from a preset sub-region set as sub-regions of the battle region. For example, FIG. 16 is a schematic diagram of region division according to an example embodiment of this disclosure. As shown in FIG. 16, a sub-region set 1610 is currently displayed. For sub-region division in a battle region 1601 in a virtual scene 1600, four sub-regions 1620 in the sub-region set 1610 are selected as the sub-regions in the battle region 1601.

In summary, according to the virtual scene effect display method provided in the embodiments of this disclosure, when the main control virtual object is located in the battle region in the virtual scene, the first highlight effect of the plurality of sub-regions is displayed in the battle region. The first highlight effect represents that the sub-region is the to-be-selected candidate region. After the display of the first highlight effect ends, the second highlight effect is displayed on the selected sub-region, to represent the attribute impact of the selected sub-region on the main control virtual object. Finally, the attribute impact result is displayed based on the position relationship between the main control virtual object and the selected sub-region. That is, a player can be prompted for a current candidate region by displaying the first highlight effect, and then the second highlight effect of the selected sub-region is displayed. A region causing an attribute impact can be affected by two highlight effects. In this way, the player cannot know a specific position of the selected sub-region in advance, and diversity of effect display can be improved, thereby improving interactivity of the player in the game process. In addition, a manner of displaying the highlight effect can play a push role for a game process, thereby avoiding a waste of resources of a server.

FIG. 17 is a structural block diagram of a virtual scene effect display apparatus according to an example embodiment of this disclosure. As shown in FIG. 17, the apparatus includes the following parts:
a first display module 1710, configured to display a main control virtual object, the main control virtual object being located in a battle region in a virtual scene, the battle region including a plurality of sub-regions; and
the first display module 1710 is further configured to display a first highlight effect in the plurality of sub-regions in the battle region, the first highlight effect being configured for representing that the plurality of sub-regions are to-be-selected candidate regions; and
a second display module 1720, configured to display a second highlight effect in a selected sub-region in the plurality of sub-regions after the display of the first highlight effect ends, the second highlight effect being configured for representing an attribute impact of the selected sub-region on the main control virtual object; and
the second display module 1720 is further configured to display an attribute impact result of the main control virtual object based on a position relationship between the main control virtual object and the selected sub-region.

In some embodiments, as shown in FIG. 18, the second display module 1720 includes:
an obtaining unit 1721, configured to randomly obtain the selected sub-region from the plurality of sub-regions after the display of the first highlight effect ends; or obtain the selected sub-region from the plurality of sub-regions based on a preset obtaining condition after the display of the first highlight effect ends; and
a display unit 1722, configured to display the second highlight effect in the selected sub-region.

In some embodiments, the second highlight effect is displayed on the selected sub-region within a preset time range.

In some embodiments, the second display module 1720 is further configured to: obtain an object position of the main control virtual object; and display a first impact result of the main control virtual object in response to the object position being within the selected sub-region; or display a second impact result of the main control virtual object in response to the object position being located outside the selected sub-region, the first impact result and the second impact result being different.

In some embodiments, the first display module 1710 is further configured to display region prompt information, the region prompt information being configured for prompting the main control virtual object to move to the selected sub-region within the preset time range.

In some embodiments, the first display module 1710 is further configured to display a plurality of rounds of first highlight effects in the battle region, the round being configured for representing a number of display times of the first highlight effect, where the first highlight effect is displayed for at least one sub-region in the plurality of sub-regions in a single round.

In some embodiments, the virtual scene further includes a battle virtual object, the battle virtual object performing a virtual battle with the main control virtual object in the battle region; and
the first display module 1710 is further configured to periodically display, in response to an attribute value of the battle virtual object reaching a first attribute threshold in a process of the virtual battle, the plurality of rounds of first highlight effects on the plurality of sub-regions in the battle region in sequence.

In some embodiments, the battle region is a circular roulette region, the circular roulette region including a plurality of sector sub-regions.

In some embodiments, the first display module 1710 is further configured to: determine, in a single round, some sub-regions based on a skill casting direction of the battle virtual object, a display position of the sub-regions being consistent with the skill casting direction; and display the first highlight effect in the sub-regions.

In some embodiments, the second display module 1720 is further configured to cancel the display of the second highlight effect in response to the attribute value of the battle virtual object reaching a second attribute threshold before the display of the second highlight effect ends.

In some embodiments, the first display module 1710 is further configured to: obtain first rendering data; perform effect rendering on the plurality of sub-regions based on the first rendering data, to obtain first rendering results respectively corresponding to the plurality of sub-region; and display the plurality of rounds of first highlight effects based on the first rendering result.

In summary, according to the virtual scene effect display apparatus provided in the embodiments of this disclosure, when the main control virtual object is located in the battle region in the virtual scene, the first highlight effect of the plurality of sub-regions is displayed in the battle region. The first highlight effect represents that the sub-region is the to-be-selected candidate region. After the display of the first highlight effect ends, the second highlight effect is displayed on the selected sub-region, to represent the attribute impact of the selected sub-region on the main control virtual object. Finally, the attribute impact result is displayed based on the position relationship between the main control virtual object and the selected sub-region. That is, the player can be prompted for a current candidate region by displaying the highlight effect, and then the second highlight effect of the selected sub-region is displayed. A region causing an attribute impact can be affected by two highlight effects. In this way, the player cannot know a specific position of the selected sub-region in advance, and diversity of effect display can be improved, thereby improving interactivity of the player in a game process. In addition, a manner of displaying the highlight effect can play a push role for a game process, thereby avoiding a waste of resources of the server.

The effect display apparatus of a virtual scene provided in the foregoing embodiments is merely illustrated with an example of division of each functional module. In actual disclosure, the functions may be allocated to and completed by different functional modules according to requirements, that is, an internal structure of the device is divided into different functional modules, to implement all or some of the functions described above. In addition, the virtual scene effect display apparatus provided in the foregoing embodiment belongs to the same concept as the virtual scene effect display method embodiment. For a specific implementation process of the apparatus, refer to the method embodiment. Details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

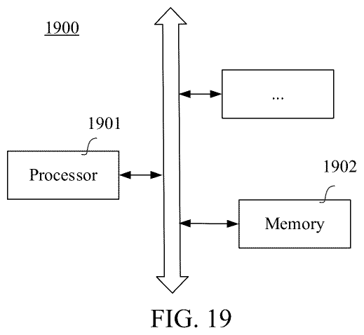

FIG. 19 is a structural block diagram of a terminal 1900 according to an example embodiment of this disclosure. The terminal 1900 may be: a smartphone, a tablet computer, a moving picture experts group audio layer III (MP3) player, a moving picture experts group audio layer IV (MP4) player, a notebook computer, or a desktop computer. The terminal 1900 may also be referred to by other names as user equipment, a portable terminal, a laptop terminal, a desktop terminal, etc.

Generally, a terminal 1900 includes: a processor 1901 and a memory 1902.

Processing circuitry, such as the processor 1901 may include one or more processing cores, such as a 4-core processor or an 8-core processor. The processor 1901 may be implemented by using at least one hardware form of a digital signal processing (DSP), a field-programmable gate array (FPGA), and a programmable logic array (PLA).

The memory 1902, such as a non-transitory computer-readable storage medium, may include one or more computer-readable storage media. The computer-readable storage media may be non-transitory. The memory 1902 may further include a high-speed random access memory, as well as non-volatile memory, such as one or more disk storage devices and flash storage devices. In some embodiments, the non-transitory computer-readable storage medium in the memory 1902 is configured to store at least one instruction. The at least one instruction is executed by the processor 1901 to implement the virtual battle control method according to the method embodiments in this disclosure.

In some embodiments, the terminal 1900 further include another component. A person skilled in the art may understand that the structure shown in FIG. 19 does not constitute a limitation to the terminal 1900, and the terminal 1900 may include more or fewer components than those shown in the figure, or some components may be combined, or a different component deployment may be used.

A person of ordinary skill in the art may understand that all or some of the operations of the methods in the embodiments may be implemented by a program instructing relevant hardware. The program may be stored in a computer-readable storage medium. The computer-readable storage medium may be the computer-readable storage medium included in the memory in the foregoing embodiment, or may be a computer-readable storage medium that exists independently and that is not assembled in a terminal. The computer-readable storage medium stores at least one instruction, at least one program, a code set or an instruction set, the at least one instruction, the at least one program, the code set or the instruction set being loaded and executed by a processor to implement the virtual scene effect display method according to any one of the foregoing embodiments. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In some embodiments, the computer-readable storage medium may include: a read only memory (ROM), a random access memory (RAM), a solid state drive (SSD), an optical disc, or the like. The RAM may include a resistance random access memory (ReRAM) and a dynamic random access memory (DRAM). The sequence numbers of the foregoing embodiments of this disclosure are merely for description purpose, and do not indicate the preference of the embodiments.

What is claimed is:

1. A method for displaying an effect in a virtual scene, the method comprising:
displaying a main virtual object in a battle region of the virtual scene, the battle region including a plurality of battle subregions;
displaying a first highlight effect in the plurality of battle subregions, the first highlight effect indicating that the plurality of battle subregions is available to be selected; and
displaying a second highlight effect in a selected subregion of the plurality of battle subregions, the second highlight effect representing an impact attribute of the selected subregion of the main virtual object, wherein
the impact attribute is based on a location of the main virtual object and the selected subregion.

2. The method according to claim 1, wherein the displaying the second highlight effect further comprises:
obtaining the selected subregion from the plurality of battle subregions based on a preset condition after the displaying of the first highlight effect is ended; and
displaying the second highlight effect in the selected subregion.

3. The method according to claim 2, wherein the preset condition is a preset time range.

4. The method according claim 1, wherein the displaying the second highlight effect further comprises:
displaying a first impact result of the main virtual object when the location of the main virtual object is within the selected subregion; or
displaying a second impact result of the main virtual object when the location of the main virtual object is outside the selected subregion.

5. The method according to claim 1, further comprising:
displaying region prompt information, the region prompt information prompting the main virtual object to move to the selected subregion within a preset time range.

6. The method according to claim 1, wherein the displaying the first highlight effect further comprises:
displaying at least one round of the first highlight effect in the battle region, the at least one round corresponding to a number of times that the first highlight effect is displayed.

7. The method according to claim 1, further comprising:
displaying, based on an attribute value of a battle virtual object of the virtual scene reaching a first attribute threshold in a virtual battle with the main virtual object, a plurality of rounds of the first highlight effect in the plurality of battle subregions in an order.

8. The method according to claim 7, wherein the battle region is a circle and the plurality of battle subregions are sectors of the circle.

9. The method according to claim 7, wherein the displaying the plurality of rounds further comprises:
determining the displaying order of the first highlight effect in a single round based on a skill casting direction of the battle virtual object; and
displaying the first highlight effect in the battle subregions according to the determined order.

10. The method according to claim 9, further comprising:
stop displaying the second highlight effect when the attribute value of the battle virtual object reaches a second attribute threshold before the displaying of the second highlight effect ends.

11. The method according to claim 1, wherein the displaying the first highlight effect further comprises:
obtaining first rendering data;
performing effect rendering on the plurality of battle subregions based on the first rendering data; and
displaying the first highlight effect of a single round based on the performed effect rendering.

12. An information processing apparatus, comprising:
processing circuitry configured to:
display a main virtual object in a battle region of a virtual scene, the battle region including a plurality of battle subregions;
display a first highlight effect in the plurality of battle subregions, the first highlight effect indicating that the plurality of battle subregions is available to be selected; and
display a second highlight effect in a selected subregion of the plurality of battle subregions, the second highlight effect representing an impact attribute of the selected subregion of the main virtual object, wherein
the impact attribute is based on a location of the main virtual object and the selected subregion.

13. The information processing apparatus according to claim 12, wherein the processing circuitry is configured to:
obtain the selected subregion from the plurality of battle subregions based on a preset condition after the display of the first highlight effect is ended; and
display the second highlight effect in the selected subregion.

14. The information processing apparatus according to claim 12, wherein the processing circuitry is configured to:
display, based on an attribute value of a battle virtual object of the virtual scene reaching a first attribute threshold in a virtual battle with the main virtual object, a plurality of rounds of the first highlight effect in the plurality of battle subregions in an order.

15. The information processing apparatus according to claim 14, wherein the battle region is a circle and the plurality of battle subregions are sectors of the circle.

16. The information processing apparatus according to claim 14, wherein the processing circuitry is configured to:
determine the display order of the first highlight effect in a single round based on a skill casting direction of the battle virtual object; and
display the first highlight effect in the battle subregions according to the determined order.

17. A non-transitory computer-readable storage medium, storing instructions which when executed by a processor cause the processor to perform:
displaying a main virtual object in a battle region of a virtual scene, the battle region including a plurality of battle subregions;
displaying a first highlight effect in the plurality of battle subregions, the first highlight effect indicating that the plurality of battle subregions is available to be selected; and
displaying a second highlight effect in a selected subregion of the plurality of battle subregions, the second highlight effect representing an impact attribute of the selected subregion of the main virtual object, wherein
the impact attribute is based on a location of the main virtual object and the selected subregion.

18. The non-transitory computer-readable storage medium according to claim 17, wherein the instructions when executed by the processor further cause the processor to perform:
obtaining the selected subregion from the plurality of battle subregions based on a preset condition after the displaying of the first highlight effect is ended; and
displaying the second highlight effect in the selected subregion.

19. The non-transitory computer-readable storage medium according to claim 17, wherein the instructions when executed by the processor further cause the processor to perform:
displaying, based on an attribute value of a battle virtual object of the virtual scene reaching a first attribute threshold in a virtual battle with the main virtual object, a plurality of rounds of the first highlight effect in the plurality of battle subregions in an order.

20. The non-transitory computer-readable storage medium according to claim 19, wherein the instructions when executed by the processor further cause the processor to perform:
determining the displaying order of the first highlight effect in a single round based on a skill casting direction of the battle virtual object; and
displaying the first highlight effect in the battle subregions according to the determined order.
